(19) United States
(12) Patent Application Publication
(10) Pub. No.: US 2019/0005197 A1
(43) Pub. Date: Jan. 3, 2019

(54) METHOD TO PROMPT CLINICAL PRACTICE GUIDELINE AND SYSTEM THEREOF

(71) Applicant: Manifold Health Tech, Inc., Grand Cayman (KY)

(72) Inventor: Bo-Ru Wu, Grand Cayman (KY)

(21) Appl. No.: 15/641,131

(22) Filed: Jul. 3, 2017

(51) Int. Cl. G06F 19/00; G06F 17/30

(52) U.S. Cl. CPC G06F 19/322; G06F 17/30424; G06F 17/30595

(57) ABSTRACT

A method to prompt a clinical practice guideline and a system used for executing the method are provided. The system includes a relational database and a rule database. The relational database stores at least one medical record data set corresponding to at least one patient. The medical record data set includes at least one medical record data corresponding to the patient. The rule database stores a plurality of preset clinical practice guideline rules. The method includes the following steps of: (a) loading a medical record data set corresponding to a patient; (b) loading a clinical practice guideline rule related to the patient; (c) generating a clinical practice guideline prompt message corresponding to the patient; and (d) providing a user with the practice guideline prompt message corresponding to the patient to be queried.

### FIELD OF THE INVENTION

The present invention relates to a method and a system used for healthcare prompts, and more particularly to a method to prompt a clinical practice guideline and a system thereof.

### BACKGROUND OF THE INVENTION

Clinical practice guidelines refer to the best care recommendations by means of a systematic literature review to assist physicians and patients in determining the most appropriate healthcare. The object is to promote an effective and efficient care, that is, to guide physicians to provide a high-quality care in a more beneficial manner.

However, in practice, the rules of the clinical practice guidelines are too numerous, and the patient's medical records are too scattered, resulting in that physicians need a longer assessment time. For critical patients, the diagnosis and treatment are against the clock. It often cannot have plenty of time for the physician to assess, which may lead to medication errors or inappropriate cares.

### SUMMARY OF THE INVENTION

The primary object of the present invention is to provide a method to prompt a clinical practice guideline, executed with a system to prompt the clinical practice guideline. The system comprises a relational database and a rule database. The relational database stores at least one medical record data set corresponding to at least one patient. The medical record data set comprises at least one medical record data corresponding to the patient. The rule database stores a plurality of preset clinical practice guideline rules. The method comprises the following steps of: (a) loading a medical record data set corresponding to a patient to be queried from the relational database; (b) loading a clinical practice guideline rule related to the patient to be queried from the rule database; (c) generating a clinical practice guideline prompt message corresponding to the patient to be queried based on the medical record data set corresponding to the patient to be queried and the clinical practice guideline rule related to the patient to be queried; and (d) providing a user with the practice guideline prompt message corresponding to the patient to be queried.

Another object of the present invention is to provide a system to prompt a clinical practice guideline. The system comprises a relational database, a rule database, a load module, a prompt message generation module, and a user interface. The relational database stores at least one medical record data set corresponding to at least one patient. The medical record data set comprises at least one medical record data corresponding to the patient. The rule database stores a plurality of preset clinical practice guideline rules. The load module is used for loading a medical record data set corresponding to a patient to be queried from the relational database and loading a clinical practice guideline rule related to the patient to be queried from the rule database. The prompt message generation module is used for generating a clinical practice guideline prompt message corresponding to the patient to be queried based on the medical record data set corresponding to the patient to be queried and the clinical practice guideline rule related to the patient to be queried. The user interface is used for providing a user with the clinical practice guideline prompt message corresponding to the patient to be queried.

The beneficial effect of the present invention is to provide the user (e.g., a physician) with the clinical practice guideline prompt message corresponding to the patient to be queried based on the medical record data set corresponding to the patient to be queried and the clinical practice guideline rule related to the patient to be queried, thereby shortening the assessment time for the user and reducing the probability of medication errors or inappropriate cares.

### BRIEF DESCRIPTION OF THE DRAWINGS

FIG. 1 is a block diagram, illustrating a system to prompt a clinical practice guideline according to a preferred embodiment of the present invention; and

FIG. 2 is a flow chart, illustrating a method to prompt a clinical practice guideline according to a preferred embodiment of the present invention.

### DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein.

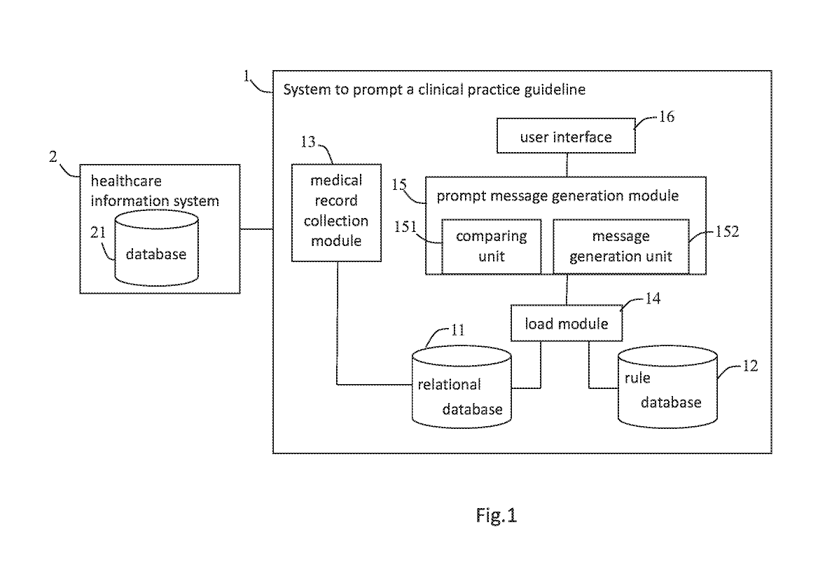

FIG. 1 is a block diagram, illustrating a system 1 to prompt a clinical practice guideline according to a preferred embodiment of the present invention. The system 1 is adapted to be operated in conjunction with a healthcare information system 2. The system 1 to prompt a clinical practice guideline comprises a relational database 11, a rule database 12, a medical record collection module 13, a load module 14, a prompt message generation module 15, and a user interface 16. The healthcare information system 2 comprises a database 21.

The healthcare information system 2 refers to an information system used by most hospitals. The database 21 stores a plurality of medical record data corresponding to a plurality of patients, respectively.

In the preferred embodiment, the relational database 11 and the rule database 12 are pre-established, and the stored data are continuously updated. The relational database 11 stores at least one medical record data set corresponding to at least one patient. The medical record data set comprises at least one medical record data corresponding to the patient. The rule database 12 stores a plurality of preset clinical practice guideline rules. The medical record collection module 13 is used to periodically obtain the medical record data corresponding to the patient from the database 21 of the healthcare information system 2 to be collected to form the medical record data set corresponding to the patient, and then the medical record data set corresponding to the patient is written into the relational database 11.

The user interface 16 is used for a user (e.g., a physician) to input a query request corresponding to a patient to be queried. In the preferred embodiment, the query request may include basic information and illness related to the patient to be queried. The implementation of the user interface 16 is an application in conjunction with an input unit (not shown, such as, a touch screen, a keyboard, or a voice input unit) and an output unit (not shown, such as, a screen, or a loudspeaker) to provide the user with the interactive operation function.

The load module 14 is used for loading a medical record data set corresponding to the patient to be queried from the relational database 11 and for loading a clinical practice guideline rule related to the patient to be queried from the rule database 12. Furthermore, the load module 14 receives the query request, and loads the medical record data set corresponding to the patient to be queried from the relational database 11, and loads the clinical practice guideline rule related to the patient to be queried from the rule database 12. For example, the load module 14 loads the medical record data set corresponding to the patient to be queried from the relational database 11 based on the basic information of the patient to be queried. The load module 14 further loads the clinical practice guideline rule related to the patient to be queried from the rule database 12 based on the illness of the patient to be queried.

The prompt message generation module 15 is used for generating a clinical practice guideline prompt message corresponding to the patient to be queried based on the medical record data set corresponding to the patient to be queried and the clinical practice guideline rule related to the patient to be queried. Further, the prompt message generation module 15 includes a comparing unit 151 and a message generation unit 152. The comparing unit 151 is used for comparing each medical record data of the medical record data set corresponding to the patient to be queried with the clinical practice guideline rule related to the patient to be queried. The message generation unit 152 is used for generating the clinical practice guideline prompt message corresponding to the patient to be queried based on the medical record data conforming to the clinical practice guideline rule. In the preferred embodiment, the message generation unit 152 of the prompt message generation module 15 is also used for converting the clinical practice guideline prompt message corresponding to the patient to be queried into a JSON format and transmitting it to the user interface 16.

The user interface 16 may be used for providing the user with the clinical practice guideline prompt message corresponding to the patient to be queried. For example, the user interface 16 may provide the user with the clinical practice guideline prompt message through the output unit (not shown) by means of characters, an acousto-optic effect, or the like.

In order to make the operation of each of the components of the aforesaid system 1 more clearly understood, the following description illustrates a method to prompt a clinic practice guideline in accordance with a preferred embodiment of the present invention.

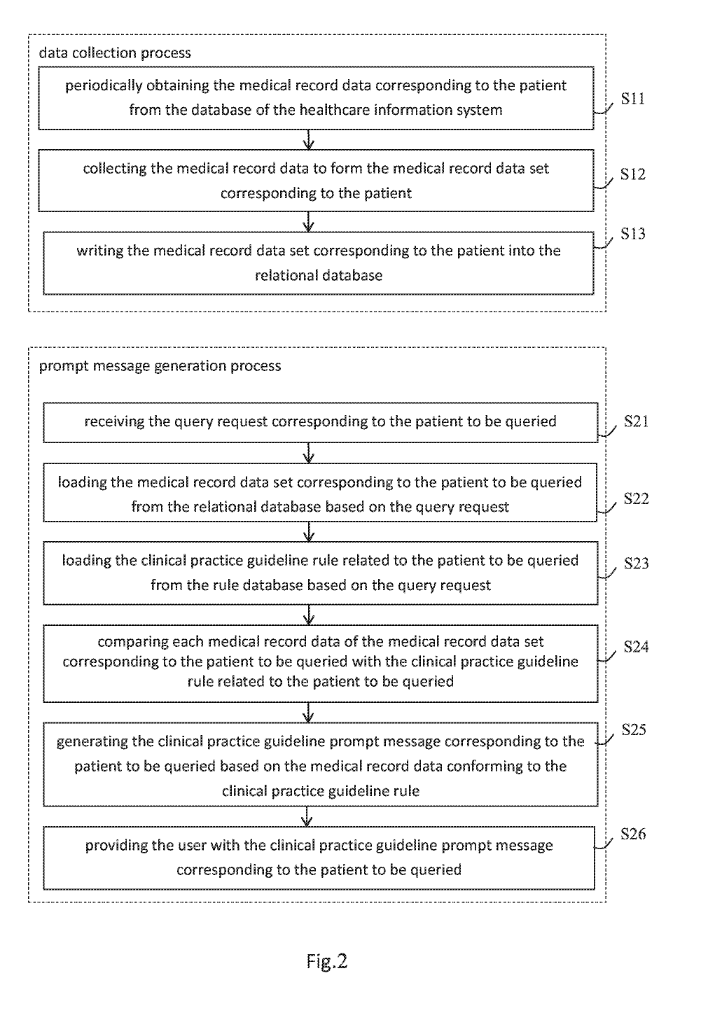

Referring to FIG. 1 and FIG. 2, the method to prompt a clinic practice guideline comprises two processes, a data collation process and a prompt message generation process. The data collection process must be executed at least once before executing the prompt message generation process.

The data collection process comprises the following steps of:

as shown in step S11, periodically obtaining the medical record data corresponding to the patient from the database 21 of the healthcare information system 2;

as shown in step S12, collecting the medical record data to form the medical record data set corresponding to the patient;

as shown in step S13, writing the medical record data set corresponding to the patient into the relational database 11.

The prompt message generation process comprises the following steps of:

as shown in step S21, receiving the query request corresponding to the patient to be queried;

as shown in step S22, loading the medical record data set corresponding to the patient to be queried from the relational database based on the query request;

as shown in step S23, loading the clinical practice guideline rule related to the patient to be queried from the rule database 12 based on the query request;

as shown in step S24, comparing each medical record data of the medical record data set corresponding to the patient to be queried with the clinical practice guideline rule related to the patient to be queried;

as shown in step S25, generating the clinical practice guideline prompt message corresponding to the patient to be queried based on the medical record data conforming to the clinical practice guideline rule; and

as shown in step S26, converting the clinical practice guideline prompt message corresponding to the patient to be queried into a JSON format to be transmitted to the user interface 16, and then providing it to the user through the output unit.

In summary, the system to prompt a clinical practice guideline of the present invention can provide the user with the clinical practice guideline prompt message corresponding to the patient to be queried based on the medical record data set corresponding to the patient to be queried and the clinical practice guideline rule related to the patient to be queried, thereby shortening the assessment time for the user and reducing the probability of medication errors or inappropriate cares. Therefore, the object of the present invention can be achieved.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A method to prompt a clinical practice guideline, executed with a system to prompt the clinical practice guideline, the system comprising a relational database and a rule database, the relational database storing at least one medical record data set corresponding to at least one patient, the medical record data set comprising at least one medical record data corresponding to the patient, the rule database storing a plurality of preset clinical practice guideline rules, the method comprising the following steps of:
(a) loading a medical record data set corresponding to a patient to be queried from the relational database;
(b) loading a clinical practice guideline rule related to the patient to be queried from the rule database;
(c) generating a clinical practice guideline prompt message corresponding to the patient to be queried based on the medical record data set corresponding to the patient to be queried and the clinical practice guideline rule related to the patient to be queried; and
(d) providing a user with the practice guideline prompt message corresponding to the patient to be queried.

2. The method as claimed in claim 1, wherein the step (c) further comprises the following sub-steps of:
(c-1) comparing each medical record data of the medical record data set corresponding to the patient to be queried with the clinical practice guideline rule related to the patient to be queried; and
(c-2) generating the clinical practice guideline prompt message corresponding to the patient to be queried based on the medical record data conforming to the clinical practice guideline rule.

3. The method as claimed in claim 1, adapted to be operated in conjunction with a healthcare information system, the healthcare information system comprising a database, the method further comprising the following steps of:
(e) periodically obtaining the medical record data corresponding to the patient from the database of the healthcare information system;
(f) collecting the medical record data to form the medical record data set corresponding to the patient; and
(g) writing the medical record data set corresponding to the patient into the relational database.

4. The method as claimed in claim 1, before the step (a), further comprising the following steps of:
(h) receiving a query request corresponding to the patient to be queried;
wherein in the step (a), the medical record data set corresponding to the patient to be queried is loaded from the relational database based on the query request; wherein in the step (b), the clinical practice guideline rule related to the patient to be queried is loaded from the rule database based on the query request.

5. The method as claimed in claim 1, wherein in the step (d), the clinical practice guideline prompt message corresponding to the patient to be queried is converted into a JSON format and then provided for the user.

6. A system to prompt a clinical practice guideline, comprising:
a relational database, storing at least one medical record data set corresponding to at least one patient, wherein the medical record data set comprises at least one medical record data corresponding to the patient; a rule database, storing a plurality of preset clinical practice guideline rules;
a load module, used for loading a medical record data set corresponding to a patient to be queried from the relational database and loading a clinical practice guideline rule related to the patient to be queried from the rule database;
a prompt message generation module, used for generating a clinical practice guideline prompt message corresponding to the patient to be queried based on the medical record data set corresponding to the patient to be queried and the clinical practice guideline rule related to the patient to be queried; and
a user interface, used for providing a user with the clinical practice guideline prompt message corresponding to the patient to be queried.

7. The system as claimed in claim 6, wherein the prompt message generation module includes a comparing unit and a message generation unit, the comparing unit is used for comparing each medical record data of the medical record data set corresponding to the patient to be queried with the clinical practice guideline rule related to the patient to be queried, and the message generation unit is used for generating the clinical practice guideline prompt message corresponding to the patient to be queried based on the medical record data conforming to the clinical practice guideline rule.

8. The system as claimed in claim 6, adapted to be operated in conjunction with a healthcare information system, the healthcare information system comprising a database, the system further comprising a medical record collection module used to periodically obtain the medical record data corresponding to the patient from the database of the healthcare information system to be collected to form the medical record data set corresponding to the patient, the medical record data set corresponding to the patient being written into the relational database.

9. The system as claimed in claim 6, wherein the user interface is used for the user to input a query request corresponding to the patient to be queried, the load module receives the query request and loads the medical record data set corresponding to the patient to be queried from the relational database, and loads the clinical practice guideline rule related to the patient to be queried from the rule database.

10. The system as claimed in claim 6, wherein the prompt message generation module is further used for converting the clinical practice guideline prompt message corresponding to the patient to be queried into a JSON format to be transmitted to the user interface.
